(19) United States
(12) Patent Application Publication
(10) Pub. No.: US 2023/0227660 A1
(43) Pub. Date: Jul. 20, 2023

(54) WATER REPELLENT COMPOSITIONS

(71) Applicant: Energenics Europe Ltd, Begbroke, Oxford, Oxfordshire (GB)

(72) Inventors: Yingqian XU, Begbroke, Oxford, Oxfordshire (GB); Mike ATTFIELD, Begbroke, Oxford, Oxfordshire (GB); Riaz CHOUDHERY, Begbroke, Oxford, Oxfordshire (GB)

(21) Appl. No.: 18/007,110

(22) PCT Filed: Jul. 26, 2021
(86) PCT No.: PCT/EP2021/070897

§ 371 Date: Jan. 27, 2023

(30) Foreign Application Priority Data
Jul. 28, 2020 (GB) 2011692.7

(51) Int. Cl. C09D 1/00; C09D 7/20; C09D 5/14

(52) U.S. Cl. CPC C09D 1/00; C09D 7/20; C09D 5/14

(57) ABSTRACT

A method of increasing water repellency of an organic porous substrate, such as wood, is provided. The method comprises applying a dispersion of inorganic nanoparticles in a liquid carrier onto a surface of the substrate. The liquid carrier is selected to evaporate substantially entirely at room temperature. For example, the liquid carrier may be selected so that at least 95% of the liquid carrier will evaporate at room temperature, preferably in a 24 hour period following application to the substrate surface.

### TECHNICAL FIELD

The present invention relates to a method of increasing water repellency of an organic porous substrate. In particular, the invention relates to a method of improving water repellency of wood.

### BACKGROUND

Wood is a widely used material because it is sustainable and has many useful properties, including strength, durability, and attractive appearance. Unfortunately, wood also has some drawbacks, including its ability to absorb water. This can have deleterious effects, such as expansion of the wood (loss of dimensional stability) and promotion of biological activity e.g. growth of microbes, algae, fungus, and the like. This biological activity can compromise the wood's appearance, especially when it is used for exterior applications such as buildings, building structures (e.g. doors, window frames, piers and walkways), decking and fences.

To reduce absorption of water by wood, its surface is often made water repellent, or hydrophobic. Wood may be made water repellent using one of the following methods, all of which have drawbacks as outlined below:

a) Chemical treating the wood surface to render it hydrophobic. This approach often relies upon the use of corrosive chemicals (e.g. acetic anhydride or acetyl chloride) or chemicals (e.g. alkyl silanes) that emit organics into the environment, thereby contributing to global warming.

b) Application of hydrophobic oils/waxes to the surface of the wood. This approach has limited service life since oils/waxes degrade and are readily lost to the environment (e.g. by leaching)

c) Application of paint to the wood surface. This approach obscures the natural appearance of the wood thereby hiding its natural beauty.

d) Application of a clear varnish to the wood surface. Over a period of time, varnishes tend to crack and detach from the wood surface, allowing water to collect between the wood and varnish and resulting in the formation of blisters. These blisters become a natural environment for biological activity and so result in the loss of the attractive appearance of the wood.

It is therefore desirable to provide compositions that make wood water repellent but do not suffer from the aforementioned drawbacks.

### SUMMARY

In one aspect, a method of increasing water repellency of an organic porous substrate is provided. The method comprises applying a dispersion of inorganic nanoparticles in a liquid carrier onto a surface of the substrate. The liquid carrier is selected to evaporate substantially entirely at room temperature following application to the substrate surface.

The liquid carrier is preferably selected so that at least 95% of said liquid carrier evaporates, preferably within 24 hours following application to the substrate.

Preferably, the liquid carrier may be selected to evaporate substantially entirely within 24 hours of application of the dispersion to the substrate.

The inorganic nanoparticles may comprise cerium oxide.

The inorganic nanoparticles may comprise only cerium oxide.

The liquid carrier may be an aqueous carrier. The liquid carrier may contain hydrogen peroxide. The pH of the dispersion may be between 1 and 10, preferably between 2 and 9, more preferably between 2.5 and 8 and most preferably between 3 and 7.

Nanoparticle sizes may include: 1-500 nm, preferably 1-100 nm, more preferably 1-50 nm, and most preferably 2-30 nm.

Nanoparticles content of the dispersion may be: between 0.1 and 20% by weight, preferably 0.2-10% by weight and most preferably between 0.4 and 5% by weight.

Dried application weight of nanoparticles may be: from 0.1 g/sqm to 20 g/sqm, preferably 0.3 g/sqm to 10 g/sm and most preferably 0.5 g/sqm to 5 g/sqm.

The porous organic substrate may comprise one or more of: wood, modified wood, wood-based, wood-derived or lignin-based material.

The method may comprise applying the dispersion of inorganic nanoparticles directly onto the surface of the substrate. The applying may include treatment by brushing, painting, spraying, dipping and curtain/roller coating.

The dispersion may contain only inorganic nanoparticles and the liquid carrier. The liquid carrier may be an aqueous carrier. The liquid carrier may contain hydrogen peroxide. The dispersion may have a pH of substantially between 1 and 10, preferably between 2 and 9, more preferably between 2.5 and 8 and most preferably between 3 and 7.

The dispersion may contain only inorganic nanoparticles, biocides and/or fungicides and the liquid carrier. The dispersion may contain only inorganic nanoparticles, biocides and/or fungicides and/or hydrogen peroxide and the liquid carrier.

Following evaporation of the liquid carrier only inorganic nanoparticles, and optionally biocides and/or fungicides, may remain on the substrate.

In another aspect there is provided a dispersion of inorganic nanoparticles in a liquid carrier for increasing the hydrophobicity/water repellency of an organic porous substrate. The liquid carrier has the property of evaporating substantially entirely at room temperature following application of the dispersion to a surface of said substrate.

Preferably, the liquid carrier has the property that at least 95% of the liquid carrier evaporates at room temperature, preferably in a 24 hour period following application of the dispersion to a surface of said substrate.

Preferably, the liquid carrier may evaporate substantially entirely within 24 hours of application of the dispersion to the substrate.

The inorganic nanoparticles may comprise cerium oxide.

The inorganic nanoparticles may comprise only cerium oxide.

The liquid carrier may be an aqueous carrier. The liquid carrier may contain hydrogen peroxide. The dispersion may have a pH of substantially 1 to 10, preferably substantially 2 to 9, more preferably substantially 2.5 to 8 and most preferably substantially 3 to 7.

The organic porous substrate may comprise one or more of: wood, modified wood, wood-based, wood-derived, lignin based material.

The inorganic nanoparticles may be substantially absorbed into said substrate.

Following application to a surface of said substrate, the inorganic nanoparticles may cause an average total absorption of light in the 400 nm to 500 nm range of at least 4%.

In a still further aspect, there is provided a porous organic substrate having a hydrophobic/water repellency treatment, said treatment comprising nanoparticles of cerium oxide.

The treatment may consist only of cerium oxide nanoparticles.

The substrate may comprise one or more of: wood, modified wood, wood-based, wood-derived, lignin-based material.

The cerium oxide nanoparticles may be absorbed into a surface region of the substrate.

The treatment may also cause an average total absorption of light in the 400 nm to 500 nm range of at least 4%.

In a yet further aspect there is provided wood incorporating nanoparticles of cerium oxide with no additional underlying binding agent.

In a still further aspect there is provided wood that has been treated with the dispersion of the aspect above.

In a yet further aspect there is provided wood that has been treated using the method of the aspect above.

### BRIEF DESCRIPTION OF THE DRAWINGS

FIG. 1 is a graphical illustration of UV and HEV (high energy visible) light absorption by a selection of nano cerium oxide and modified nano cerium oxide dispersions;

FIGS. 2a to 2d illustrate images of weathered pine wood panels: untreated (FIG. 2a) and treated (FIG. 2c), and digitised versions thereof (FIGS. 2b and 2d respectively);

FIG. 3a (left to right) illustrates images of untreated/unweathered, untreated/weathered, treated/unweathered and treated/weathered fine grain western red cedar (WRC) wood panels respectively, and FIG. 3b illustrates digitised versions thereof;

FIG. 4a (left to right) illustrates images of untreated/unweathered, untreated/weathered, treated/unweathered and treated/weathered coarse grain western red cedar (WRC) wood panels respectively, and FIG. 4b digitised versions thereof; and

FIG. 5 illustrates a method of increasing water repellency of an organic porous substrate.

### DETAILED DESCRIPTION

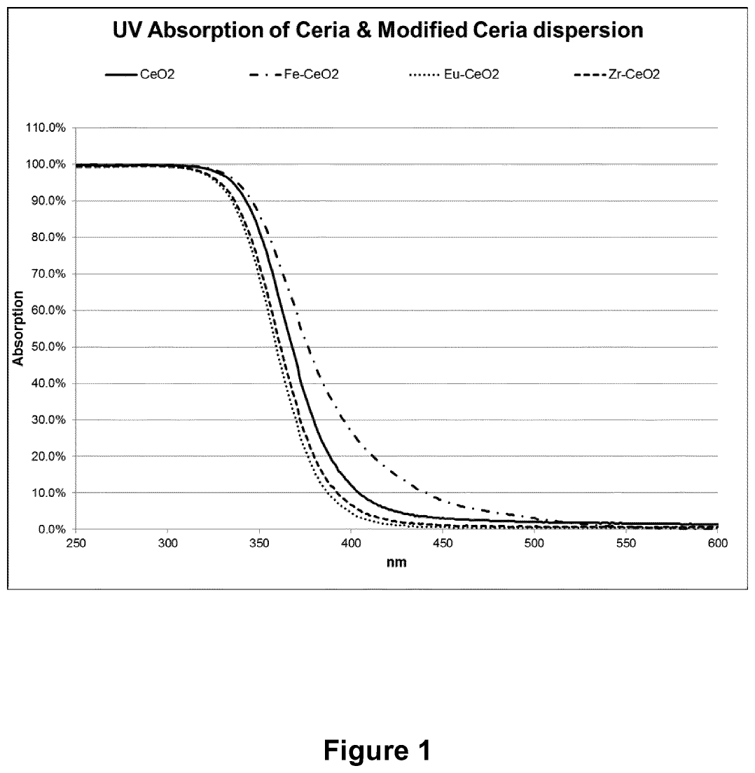

Described herein with reference to FIGS. 1 to 5 is a method of increasing water repellency of an organic porous substrate, such as wood. The method comprises applying a suspension or a dispersion of inorganic nanoparticles in a liquid carrier onto a surface of the substrate. The liquid carrier is selected to evaporate substantially entirely at room temperature following application to the substrate surface. Preferably, at least 95% of said liquid carrier will evaporate at room temperature, optionally over a 24 hour period. Also described is a dispersion of inorganic nanoparticles in a liquid carrier, which increases the hydrophobicity/water repellency of an organic porous substrate. Further described is a porous organic substrate having a hydrophobic/water repellent treatment comprising inorganic nanoparticles, optionally of cerium oxide.

The following description also includes a discussion of the properties of a substrate, such as wood, that incorporates nanoparticles of cerium oxide with no additional underlying binding agent, and wood that is treated with a dispersion containing nanoparticles of cerium oxide and water. The dispersion may also contain hydrogen peroxide. This treatment improves water repellency of the wood, and also absorbs ultraviolet light in the 400-500 nm range, optionally at a total average absorption of at least 4%.

The term “cerium oxide” as used herein refers substantially to cerium (IV) oxide (CeO₂), but may include a small amount of cerium (III) oxide (Ce₂O₃) and/or other impurities.

As described in WO2017/194959, it has been found that modifying nanoparticles of cerium oxide (referred to hereafter as nano cerium oxide) with another metal oxide, such as iron oxide, increases the absorbance of both UV light in the 350 nm to 400 nm range, and of so-called high energy visible light (HEV), generally defined as visible light within the 400 nm to 500 nm wavelength range. Both UV and HEV light is known to damage wood surfaces over time.

Nano cerium oxide “modified” with another metal oxide may comprise any of doping, coating and mixing, or combinations thereof. Doping is the incorporation (interstitial or direct replacement) of another metal oxide in the cerium oxide crystal lattice. Coating may comprise a nano cerium oxide particle having at least a partial surface coating of another metal oxide. Mixing means a mixture of discrete nano cerium oxide particles and discrete metal oxide particles.

WO2017/194959 further describes how a coating composition, such as a paint or varnish, including an additive comprising nano cerium oxide modified with another metal oxide (e.g. iron oxide, copper oxide, manganese oxide or cobalt oxide), can be optimised so that both UV and HEV light is absorbed. This can be achieved by optimising the ratio of other metal oxides, the concentration of nanoparticles, and/or the thickness of the coating composition when applied.

FIG. 1 illustrates UV and HEV light absorption by a selection of nano cerium oxide and modified nano cerium oxide dispersions. The dispersions comprise nano cerium oxide alone, and nano cerium oxide modified with iron oxide, europium oxide, and zirconium oxide, respectively. The average total absorption (%) in the 400 nm to 500 nm range (i.e. the HEV range) for each of the dispersions is shown in Table 1 below:

TABLE 1

| | CeO₂ | Fe—CeO₂ | Eu—CeO₂ | Zr—CeO₂ |
|---|---|---|---|---|
| 400-450 nm | 5.74% | 15.57% | 1.58% | 2.71% |
| 450-500 nm | 2.44% | 5.11% | 0.48% | 0.90% |
| 400-500 nm | 4.10% | 10.37% | 1.03% | 1.81% |

As shown in Table 1 above, nano cerium oxide in combination with iron oxide provides a total absorption of at least 10% of electromagnetic radiation in a wavelength band between 400 nm and 500 nm, where a dry coating of 50 μm thickness has modified nano cerium oxide at 2% by weight. The Fe—CeO₂ sample shown in FIG. 1 is Ce_{0.8}Fe_{0.2}O₂

However, the inventors have now discovered additional and unexpected properties of nano cerium oxide when prepared as an aqueous (for example) dispersion of nano cerium oxide particles. Such dispersions can be prepared by several routes, e.g. by precipitation of water soluble cerium salts or by hydrothermal means.

As described herein, an aqueous dispersion of nano cerium oxide particles relates to a dispersion in water of nano cerium oxide particles alone (i.e. not necessarily modified by metal oxides), rather than as an additive in a coating composition such as paint or varnish, or the like. It will be appreciated however that as an alternative to an aqueous dispersion, other suitable carriers, such as aliphatic hydrocarbons, may be used. Additionally or alternatively, the dispersion may comprise modified nano cerium oxide particles (i.e. nano cerium oxide modified with other metal oxides, as discussed above).

Exemplary nanoparticle sizes include: 1-500 nm, preferably 1-100 nm, more preferably 1-50 nm, and most preferably 2-30 nm. Exemplary solids contents of the nanoparticles in the dispersion include: between 0.1 and 20% by weight, preferably 0.2-10% by weight and most preferably between 0.4 and 5% by weight.

The aqueous nano cerium oxide dispersions described below may have a pH of substantially 1 to 10, preferably 2 to 9, more preferably 2.5 to 8 and most preferably 3 to 7, unless otherwise stated.

When an aqueous dispersion of nano cerium oxide is applied to a solid non-porous substrate surface, the liquid carrier (e.g. water or other suitable carrier as described above) evaporates substantially entirely, leaving behind discrete nano cerium oxide particles on the substrate surface. If the solid non-porous substrate surface is largely impervious (e.g. glass or metal) then the nano cerium oxide particles are laid down as discrete particles, or as an assembly of discrete particles, or as a monolayer of discrete particles or multilayers of discrete particles. When a drop of water is applied to the surface of the treated solid non-porous substrate, as expected the water drop deforms and spreads over the substrate surface. This indicates that the substrate surface is largely hydrophilic and so is not water repellent.

When the aqueous dispersion of nano cerium oxide is applied to a lignin-based, wood-based, or wood-derived porous solid substrate (e.g. cardboard, wood, paper) or other porous organic substrate (e.g. textiles, leather, membranes) the nano cerium oxide particles are laid down (i.e. absorbed) deep inside the pores of the treated substrate, at least within a surface region thereof, as well as at the substrate surface. Exemplary dried application weights of the nanoparticles (i.e. increase in net weight per unit area after the carrier has evaporated) include: from 0.1 g/sqm (i.e. g/m²) to 20 g/sqm, preferably 0.3 g/sqm to 10 g/sqm and most preferably 0.5 g/sqm to 5 g/sqm. Again, the liquid carrier evaporates substantially entirely, typically at room temperature, although of course evaporation may also take place at higher and/or lower temperatures. “Evaporates substantially entirely” generally means that at least 95% of the liquid carrier evaporates within 24 hours or less at room (or ambient) temperature. In practice, some of the liquid carrier may be left in the porous substrate. Alternatively, 100% of the liquid carrier may evaporate.

Upon application of water droplets to the surface of the treated porous substrate it was found that the droplets remained largely spherical in shape, indicating the substrate surface was hydrophobic in nature, i.e. water repellent.

This observation is surprising, since the laid down nano cerium oxide particles are expected to be hydrophilic. It was further surprisingly discovered that the time period required for the water droplet to be absorbed into the treated porous substrate was considerably longer than for a droplet on the untreated porous substrate.

Whilst not bound to the following explanation, the inventors believe that nano cerium oxide particles are able to bind (by chemical or electrostatic charge means), for example, to polar groups (e.g. hydroxyl groups) in constituents of the porous substrate. Such constituents in wood, modified wood, wood-based or wood-derived materials may include lignin, cellulose, and wood extractives. By binding with polar groups the nano cerium oxide particles reduce the hydrophilic nature of the wood, thereby making it hydrophobic and water repelling.

This unexpected water repellent property of surfaces of porous substrates, such as wood, that have been treated with dispersions of nano cerium oxide particles, will be further described in the following examples. The nano cerium oxide dispersion may be brushed, sprayed, dipped, roller or curtain coated, or otherwise applied directly onto the surface of the substrate to be treated (e.g. lignin-based, modified wood, wood-based, wood-derived or other organic porous substrates, such as textiles).

### Example 1: Comparative

Materials Used:

New Zealand Radiata Pine (Pine wood) wood panels, nano cerium oxide dispersion (i.e. an aqueous dispersion of nano cerium oxide particles with nano cerium oxide content of around 2.5% wt and a pH of around 3.5, and where the nanoparticles have a z-average particle size of 20 nm). It will be appreciated that there are several methods of preparing the dispersions referred to herein, as is known in the art, and any of these may be employed for the following examples.

Application Method:

The panels were brush applied with the nano cerium oxide dispersion at room temperature and allowed to dry at room temperature overnight. Untreated control wood panels were used as supplied.

Dispersion Coverage:

The coverage of the nano cerium oxide dispersion was determined by weighing the wood panels before and immediately after treatment and noting the difference in weight. The average treatment coverage and nano cerium oxide applied weight are given in Table 2 below.

TABLE 2

| | Wet Coverage | Dry CeO₂ |
|---|---|---|
| Sample | (sqm/litre) | (g/sqm) |
| Pine wood panels | 7.6 | 3.2 |

Water Repellent Determination:

Wood panels that were treated with nano cerium oxide dispersion were allowed to dry at room temperature for at least 24 hours before water repellent determination was carried out.

Both the nano cerium oxide treated and untreated (control) wood panels were wiped gently with tissue paper containing isopropyl alcohol (IPA) to clean the surfaces. The cleaned panels were left on a flat table for at least 30 minutes to ensure that any IPA on the panels had evaporated. Distilled water droplets (a minimum of 3 droplets, each around 0.05 ml) were gently pipetted onto the surface of the panels and the time taken for the water droplets to be absorbed by the wood panels was measured. The end point of the absorption of the water droplets was determined by the disappearance of the shiny meniscus surface of the water when observed at an oblique angle of about 20-30° from the horizontal.

The water repellency ratio (WRR) was determined by measuring the time taken for the water droplets to be absorbed by the nano cerium oxide treated wood panels and dividing it by the time it took for the water droplets to be absorbed by the untreated wood panels. A WRR value greater than 1 would imply that the surface of the nano cerium oxide treated wood panels was more water repellent than the surface of the untreated wood panels.

The results for water repellency are given in Table 3 below. It is clear from these results that the application of a dispersion of nano cerium oxide particles to pine wood panels greatly improves the water repellency of the panels.

TABLE 3

| | | Pine wood panels treated |
|---|---|---|
| | Pine wood | with a dispersion of nano |
| | panels | cerium oxide particles |
| Water drop absorption | 3 (+/−2) | 44 (+/−20) |
| time (mins) | | |
| Water Repellency | 1 | 14.7 |
| Ratio (WRR) | | |

Natural Weathering Test Results:

Five sets of the nano cerium oxide dispersion treated panels and five sets of untreated panels were placed on the roof (pitch angle of 22°) of a garden shed facing south. A separate set of identically nano cerium oxide treated panels and untreated panels were stored in the dark inside a laboratory as an un-weathered control. The panels for weathering were exposed on the garden shed to natural weathering conditions during January 2020 and April 2020 in the West Midlands region of the UK for a period of 12 weeks.

After the weathering period, the nano cerium oxide treated and untreated weathered panels were examined to determine the degree of black mould growth on the exposed surfaces, using the following methods.

Colour photographs of the nano cerium oxide treated and untreated weathered panels were taken. These photographs were analysed using IMAGEJ software (open source software developed by the National Institute of Health, USA and University of Wisconsin, USA). It will be appreciated, however, that alternative software with similar functionality may be used for this analysis. Said analysis comprised firstly converting the photographs into 8-bit negative black and white digital images, in which any areas of black mould appear largely as white spots. These white spots were then analysed by the software to provide various statistics, including the percentage coverage area of white spots over the wood panel.

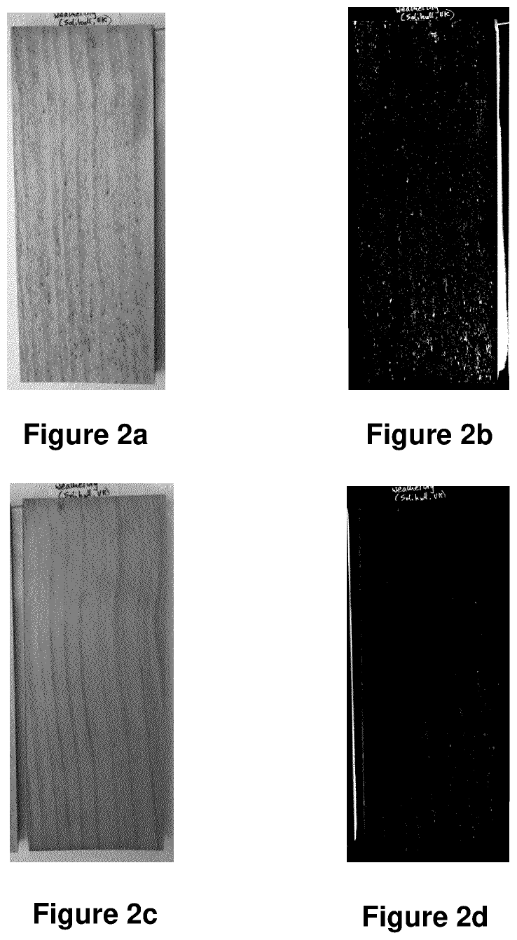

The methodology used to establish degree of black mould coverage is summarized in the photographs illustrated in FIGS. 2a-2d. FIGS. 2a and 2c respectively illustrate an untreated, weathered pine panel and a weathered pine panel previously treated with nano cerium oxide dispersion, as described above. FIG. 2b illustrates the digitised or converted black and white photograph derived from the colour photograph in FIG. 2a, and FIG. 2d illustrates the digitised or converted black and white photograph derived from the colour photograph in FIG. 2c.

Table 4 below shows the amount of black mould measured on the nano cerium oxide treated and untreated weathered wood panels. It is clear that, on average, treatment with nano cerium oxide dispersion reduced the black mould growth on pine wood panels by a factor of about 13 when compared with untreated pine wood panels.

Furthermore, from inspection of Tables 3 and 4 it is clear that the increase in water repellency of nano cerium oxide treated pine wood results in reduction of black mould growth in natural weathering tests.

TABLE 4

| | | % AREA COVERED |
|---|---|---|
| | | BY MOULD (NANO |
| | % AREA COVERED | CERIUM OXIDE |
| | BY MOULD (UNTREATED | DISPERSION TREATED |
| PANEL SET | WEATHERED PANEL) | WEATHERED PANEL) |
| 1 | 0.06 | 0.031 |
| 2 | 0.107 | 0.06 |
| 3 | 0.687 | 0.062 |
| 4 | 0.533 | 0.041 |
| 5 | 1.925 | 0.054 |
| AVERAGE | 0.662 | 0.050 |

### Example 2: Influence of Nano Cerium Oxide Concentration Upon Performance

Using the method described in Example 1 above, various concentrations of aqueous nano cerium oxide dispersion (as used in Example 1 above and diluted with distilled water to vary the concentration) were applied to wood strips each measuring 12 mm×32 mm×200 mm. The wood was obtained from Wickes (a home improvement retailer based in UK) and marketed as Whitewood Door Stop wood. After application of nano cerium oxide dispersion the treated wood was left to dry horizontally. When the nano cerium oxide dispersion treatment had dried fully (after at least 4 hours) half of the nano cerium oxide treated wood strips were coated with an outdoor satin clear varnish manufactured by Rustins Ltd, UK and marketed as “Rustins Quick Dry Outdoor Clear Varnish”. The varnished, nano cerium oxide treated strips were allowed to dry under ambient conditions for 24 hours. The remaining half of the nano cerium oxide treated wood strips were left unvarnished.

Two of the obtained wood strips were used as controls; neither was treated with nano cerium oxide dispersion; one was varnished and the other was left unvarnished. The controls were brushed with distilled water only.

The nano cerium oxide dispersion treated strips of wood and the untreated strips of wood (with and without varnish) were all subjected to natural weathering in a manner similar to that outlined in Example 1 above. After 12 weeks of weathering the wood strips were examined and the results are provided in Table 5 below.

TABLE 5

| | Concentration of nano cerium oxide in dispersion (% wt) | | | | | | |
|---|---|---|---|---|---|---|---|
| | 0 | | | | | | |
| | (control) | 0.1 | 0.2 | 0.4 | 0.6 | 1.2 | 2.5 |
| Non Varnished: | 10-20 | 5-10 | 3-10 | 3-5 | 1-3 | 0-1 | 0-1 |
| % Area with | | | | | | | |
| black | | | | | | | |
| mould/defects | | | | | | | |
| Varnished: | 5-10 | Not | Not | Not | 0-2 | 0-2 | 0-1 |
| % Area with | | Tested | Tested | Tested | | | |
| black | | | | | | | |
| mould/defects | | | | | | | |

In Table 5, defects are defined as any features that are visible to the naked eye and appear after weathering, e.g. wood fibres protruding from surface.

From the results shown in Table 5 it is clear that even using a dispersion of 0.1% wt nano cerium oxide concentration the growth of black mould on the treated, unvarnished wood strips was reduced when compared with the control strips. Furthermore, the weathering performance of the varnished wood strips is enhanced considerably when treated with nano cerium oxide dispersion.

### Example 3: Hydrocarbon Solvent Borne Nano Cerium Oxide Composition

Using the method and wood substrate described in Example 2 above, a hydrocarbon solvent based nano cerium oxide composition (i.e. a nano cerium oxide dispersion containing 2.5% by weight nano cerium oxide with a particle size around 20 nm in an aliphatic hydrocarbon liquid carrier—in this example, a liquid carrier with the tradename Exxsol D80 available from ExxonMobil Chemicals—was used to treat wood strips. The water repellency and natural weathering results obtained are given in Table 6 below.

TABLE 6

| | | Hydrocarbon |
|---|---|---|
| | | solvent based nano |
| | | cerium oxide |
| | Control | composition |
| | (untreated wood) | (treated wood) |
| Time taken to | 38(+/−6) | 69 (+/−15) |
| absorb 0.05 ml | | |
| water droplet (mins) | | |
| Water Repellency | 1 | 1.8 |
| Ratio | | |
| Non Varnished: | 15-20 | 1-2 |
| % Area with black | | |
| mould/defects | | |
| Varnished: | 25-30 | 1-5 |
| % Area with black | | |
| mould/defects | | |

Table 6 shows that the solvent based nano cerium oxide composition improved water repellency of the nano cerium oxide treated wood strips and reduced the amount of mould/surface defects after 12 weeks of natural weathering for both varnished and unvarnished treated wood. It is worth noting that for the varnished non cerium oxide treated wood (i.e. the varnished wood not treated with nano cerium oxide), the black mould growth was largely noticed under the blisters of the varnish.

### Example 4: Application Over Acetylated Wood

Using the method outlined in Example 1 above, five sets of acetylated Radiata Pine wood panels (an example of modified wood) were treated with an aqueous nano cerium oxide dispersion containing 2.5% by weight nano cerium oxide. Five sets of identical panels were left untreated as a control. The nano cerium oxide treated and untreated panels were subjected to 12 weeks natural weathering and the results obtained are given in Table 7 below.

TABLE 7

| | | % AREA COVERED |
|---|---|---|
| | % AREA COVERED | BY MOULD (Nano |
| | BY MOULD (Untreated | cerium oxide treated |
| | acetylated wood/control | acetylated wood |
| PANEL SET | weathered panel) | weathered panel) |
| 1 | 0.05 | 0.006 |
| 2 | 0.19 | 0.028 |
| 3 | 0.1 | 0.017 |
| 4 | 0.13 | 0.019 |
| 5 | 0.184 | 0.015 |
| AVERAGE | 0.131 | 0.017 |

The above results show that treatment with nano cerium oxide dispersion can reduce the growth of black mould on acetylated wood.

### Example 5: Application Over Western Red Cedar Wood (WRC)

Using the method described in Example 1 above, western red cedar (WRC) wood panels were treated with a nano cerium oxide dispersion containing 2.5% by weight nano cerium oxide. Both fine grain and coarse grain WRC wood panels were tested. The applied nano cerium oxide dispersion application weights are given in Table 8 below.

TABLE 8

| | Wet Coverage | Dry CeO₂ |
|---|---|---|
| | (sqm/litre) | (g/sqm) |
| Western Red Cedar | 8.6 | 3.0 |
| (WRC) | | |

It was surprisingly found that the application of a nano cerium oxide dispersion to WRC made the wood deeper brown in colour, making the wood more attractive and more water repellent compared with untreated WRC wood panels. The water repellency results are given in Table 9 below.

TABLE 9

| | WRC | WRC (treated with nano |
|---|---|---|
| | (untreated control) | cerium oxide dispersion) |
| Water drop absorption | 9 (+/−6) | 70 (+/−20) |
| time (mins) | | |
| Water Repellency Ratio | 1 | 7.8 |

The nano cerium oxide treated and untreated WRC wood panels were subjected to natural weathering tests and the colour fading and black mould growth results were recorded.

Natural Weathering Results: Colour Fading (after 12 Weeks)

After 12 weeks of weathering the untreated (control) WRC panels had become significantly lighter in colour while the treated panels showed significantly less fading.

The following procedure was used to assess the degree of colour fading of the untreated and treated WRC wood panels:
Photograph un-weathered and weathered WRC panels side by side at the same time (ensures same background light conditions when photograph is taken);
Use IMAGEJ or similar software to convert the photographs into 8-bit greyscale images;
Use IMAGEJ or similar software to calculate the mean grey value for the surface of each panel;
Assume the calculated mean grey value represents the degree of lightness/darkness of the wood panel surface (where a value of 0 is pure black and a value of 255 is pure white).
Assume the difference in the grey values (delta) between the un-weathered and weathered panels is a measure of degree of colour fading.

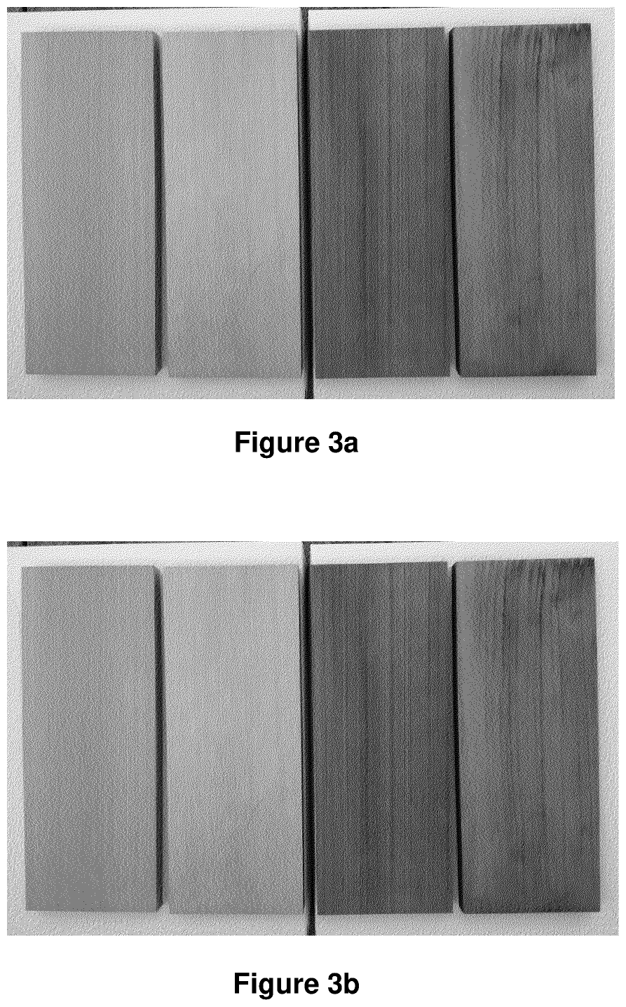

The result for the determination of degree of colour fading of the fine grain WRC wood panels is illustrated in FIGS. 3a and 3b.

FIG. 3a illustrates, from left to right, an un-weathered, untreated wood panel; a weathered, untreated wood panel; an un-weathered nano cerium oxide dispersion treated wood panel; and a weathered, nano cerium oxide dispersion treated wood panel. It can be seen that the control (untreated) panel has lost almost all its original colour after weathering. In contrast, the nano cerium oxide treated panel (which developed a deeper, richer colour following treatment) has retained much of its colour after weathering.

FIG. 3b illustrates the photographs of FIG. 3a after conversion to 8-bit grey scale images using IMAGEJ (or similar) software (where a value of 0=pure black and 255=pure white). Again, from left to right the images are: un-weathered+untreated; weathered+untreated; un-weathered+nano cerium oxide treated; weathered+nano cerium oxide treated.

The mean grey values for each fine-grained WRC panel, as calculated by the procedure outlined above, are shown in Table 10 below.

TABLE 10

| | | Delta Grey Value |
|---|---|---|
| | | (un-weathered |
| Fine grain WRC | Mean Grey Value | minus weathered) |
| Untreated un-weathered | 166 | 15 |
| Untreated weathered | 181 | |
| Nano cerium oxide | 106 | 11 |
| Treated un-weathered | | |
| Nano cerium oxide | 117 | |
| Treated weathered | | |

The % relative change in fading can be defined as:

100×(Delta grey value for Untreated Control panels−Delta grey value for Nano cerium oxide treated panels)/(Delta grey value for Untreated Control panels).

Using the above equation, for the fine grained WRC panels the % relative change in fading between the nano cerium oxide treated and untreated panels is:

100×(15−11)/15=27%.

Therefore the application of nano cerium oxide dispersion to fine grained WRC reduces the relative degree of colour fading by around 27%.

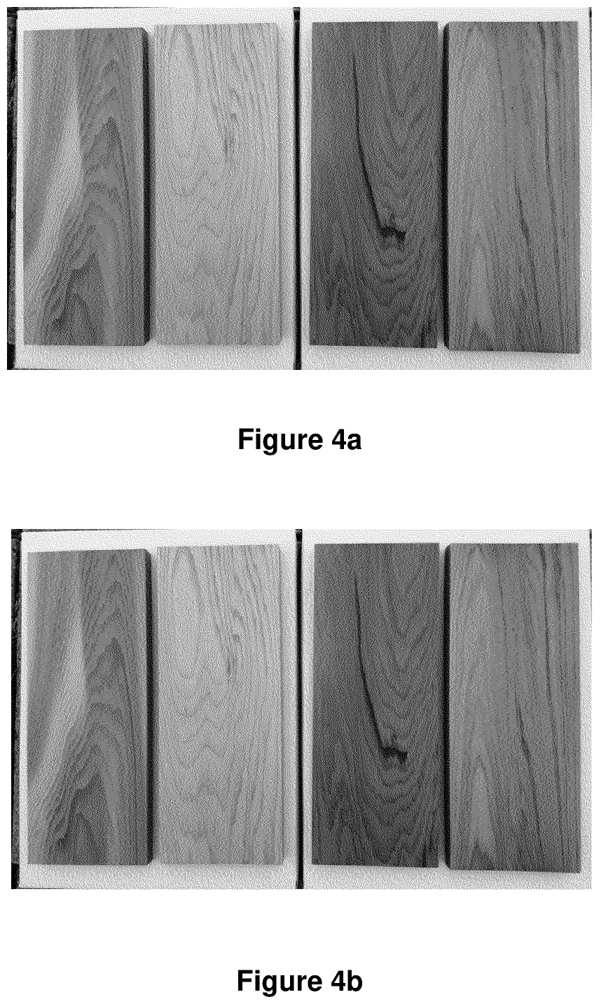

The result for the determination of degree of colour fading of the coarse grain WRC wood panels is illustrated in FIGS. 4a and 4b.

Similar to FIG. 3a, FIG. 4a illustrates, from left to right, an un-weathered, untreated wood panel; a weathered, untreated wood panel; an un-weathered nano cerium oxide dispersion treated wood panel; and a weathered, nano cerium oxide dispersion treated wood panel. It can be seen that the control (untreated) panel has lost almost all its original colour after weathering. In contrast, the nano cerium oxide treated panel (which developed a deeper, richer colour following treatment) has retained much of its colour after weathering.

FIG. 4b illustrates the photographs of FIG. 4a after conversion to 8-bit grey scale images using IMAGEJ (or similar) software (where a value of 0=pure black and 255=pure white). Again, from left to right the images are: un-weathered+untreated; weathered+untreated; un-weathered+nano cerium oxide treated; weathered+nano cerium oxide treated.

The mean grey values for each coarse-grained WRC panel, as calculated by the procedure outlined above, are shown in Table 11 below.

TABLE 11

| | | Delta Grey Value |
|---|---|---|
| | | (un-weathered |
| Coarse grain WRC | Mean Grey Value | minus weathered) |
| Untreated un-weathered | 140 | 39 |
| Untreated weathered | 179 | |
| Nano cerium oxide | 107 | 30 |
| Treated un-weathered | | |
| Nano cerium oxide | 137 | |
| Treated weathered | | |

For the coarse-grain WRC panels the % relative change in fading can be determined using the equation above as:

100×(39−30)/39=23%.

Therefore the application of nano cerium oxide dispersion to coarse grained WRC reduces the relative degree of colour fading by around 23%.

On average, therefore, treatment of WRC panels with nano cerium oxide dispersion reduces the relative degree of colour fading by (27+23)/2=25% compared with untreated WRC panels.

Natural Weathering Results: Black Mould Growth (after 22 Weeks).

Due to the inherent properties of WRC there was no obvious growth in black mould in either the nano cerium oxide treated or the untreated panels after the 12 weeks of weathering and so the weather testing was extended to 22 weeks. The results for the observed black mould growth over 5 untreated and 5 treated panels are summarized in Table 12.

TABLE 12

| | WRC | WRC (treated with nano |
|---|---|---|
| | (untreated control) | cerium oxide dispersion |
| % area affected | 5-20 | 2-5 |
| by black mould | | |
| growth after 22 | | |
| weeks of natural | | |
| weathering | | |

Inspection of Tables 10, 11 and 12 clearly demonstrate that WRC wood treated with nano cerium oxide dispersion exhibit reduced colour fading and black mould growth in natural weathering tests when compared untreated WRC wood. Furthermore, from inspection of Tables 9 and 12 it is clear that the increase in water repellency of nano cerium oxide treated WRC results in the reduction of black mould growth in natural weathering tests.

### Example 6: Application Over Dip Treated Overlap Fence

One half of a dip treated overlap garden fence panel (6 ft×6 ft available for example from Wickes in Autumn Gold colour) was brushed coated with the nano cerium oxide dispersion described in Example 1. The panel was exposed to the natural elements facing a south direction in the West Midlands region of the UK from September 2020 to June 2021. After nine months of natural weathering, the area i.e. the half treated with the nano cerium oxide treatment was largely unchanged with respect to colour change and black mould growth, whereas the area without the cerium oxide treatment showed colour change (fading) and started to show signs of black mould growth. This example demonstrates that nano cerium oxide particles can give improved natural weathering protection to wood that has been previously treated by a conventional wood treatment.

### Example 7: Comparative Example—Solution vs Particulate Cerium

Cerium Nitrate·6H₂O (6.2 g) was dissolved in de-ionised water (93.8 g) to give a clear solution containing cerium solution ions. This solution was brush applied to bare whitewood doorstop wood (available from Wickes, for example) in a manner as described in Example 1. For comparison, nano cerium oxide dispersion (as described in Example 1) was brushed onto separate pieces of bare whitewood doorstop wood also. After 2 days the water repellency ratio was determined as described in Example 1 and the results are given in Table 13. The results show that nano cerium oxide particles give much higher water repellency than cerium in the form of solutions ions.

TABLE 13

| | | 2.5% CeO2 | Cerium Nitrate |
|---|---|---|---|
| Wood Treatment | | Nano Cerium | Cerium Solution |
| Composition | None - Control | Oxide Particles | Ions |
| Water Repellency | 1.0 | 5.0 | 1.0 |
| Ratio | | | |

### Example 8: Influence of Hydrogen Peroxide

Hydrogen peroxide (30% strength, 0.81 g) was added with stirring to the nano cerium oxide dispersion described in Example 1 (50 g). The resulting mixture was left stirring for 2 hours and then applied to bare whitewood doorstop wood (available from Wickes, for example) using the method described in Example 1. For comparison, hydrogen peroxide free nano cerium oxide dispersion (i.e. nano cerium oxide dispersion without hydrogen peroxide) was applied in the same way. After 2 days the water repellency ratio was determined as described in Example 1. The results are given in Table 14. As shown in Table 14, the inclusion of hydrogen peroxide increases the water repellency ratio. In other words, the water repellency of the wood treated with nano cerium oxide dispersion including hydrogen peroxide was increased. This effect may be extended to other wood, wood-based, wood-derived, lignin-based and modified wood substrates.

TABLE 14

| Wood Treatment | | | |
|---|---|---|---|
| Composition | None - Control | 2.5% CeO₂ | 2.5% CeO₂ + H₂O₂ |
| Water Repellency | 1 | 5.0 | 7.1 |
| Ratio | | | |

As shown by the Examples above, it is unnecessary to include the nano cerium oxide dispersion as an additive in a coating composition such as paint or varnish. Indeed, inclusion of the nano cerium oxide particles in a varnish or other coating composition may diminish or prevent the above-described hydrophobic (i.e. water repellency) effect. This is somewhat counterintuitive as traditionally varnishes and the like are used to protect organic substrates such as wood from water damage.

In addition, no doping or modifying of the nano cerium oxide with metal oxides is necessary in order to provide the hydrophobic effect described above. In one exemplary, non-limiting embodiment, the dispersion to be applied directly to the substrate contains nano cerium oxide (CeO₂), water, and nothing else. In this example, a very small amount of necessary dispersing agent and/or rheology agent, discussed below, may be included in the water.

Rheology agents modify the viscosity behaviour of the nano cerium oxide dispersions making them easier to apply to the porous substrates. Such rheology agents are well known to those skilled in the art and examples can be found in: David B Braun & Meyer R Rosen “Rheology Modifiers Handbook—Practical Use & Application”, 2000, William Andrew Publishing (NY, USA) (see: https://books.google.co.uk/books/about/Rheology_Modifiers_Handbook.html?id=eMdy8qfpbhQC&printsec=frontcover&source=kp_read_button&redir_esc=y#v=onepage&q&f=false)

Dispersing and stabilising agents and surfactants are chemicals that also assist in the preparation of the dispersions and application of the nano cerium oxide dispersion to the porous substrates. These materials can help to prevent nano cerium oxide particles from flocculating in the dispersion by electrostatic and/or steric stabilization mechanisms. Such dispersing and stabilising agents and surfactants are well known those skilled in the art and some non-limiting examples can be found in: M R Porter “Handbook of surfactants”, 1991, Springer Science+Business Media (NY, USA) (see: https://books.google.co.uk/books/about/Handbook_of_Surfactants.html?id=UX3SBwAAQBAJ&printsec=frontcover&source=kp_read_button&redir_esc=y#v=onepage&q&f=false).

The above-described nano cerium oxide dispersion applied directly to the surface of the substrate provides the treated substrate with increased water repellency (i.e. increased hydrophobicity), thus reducing the growth of black mould, or other microbial activity. The reduction in mould growth may be particularly noticeable in areas of the substrate which are not in direct sunlight.

As previously described in WO2017/194959, and as shown in Table 1 above, in addition to the above hydrophobic effect, the nano cerium oxide dispersion also provides protection against damage (e.g. fading) to the substrate by UV light. This protection against UV may potentially be provided to a lesser extent than by nano cerium oxide modified with metal oxides (in particular iron oxide). As it is unnecessary to use the nano cerium oxide dispersion as an additive in a varnish, paint, wax or other protective coating or coating composition, both water repellency and some extent of UV protection may be provided by one simple, direct treatment.

Of course the nano cerium oxide dispersion could be combined with conventional wood restoration and preservative treatments, such as biocides and fungicides. These are well known to those skilled in the art and examples include chromated copper arsenate, sparingly soluble copper compounds, copper oxides/hydroxides, creosotes, 3-Iodo-2-propynyl butyl carbamate and permethrin (3-phenoxybenzyl-(1R,S)-cis, trans-2, 2-dimethyl3-(2,2-dichlorovinyl) cycloproanecarboxylate). (see: Stan T Lebow in “Wood Handbook: Chapter 15: Wood Preservation”, 2010, US department of Agriculture (Washington D.C., USA)).

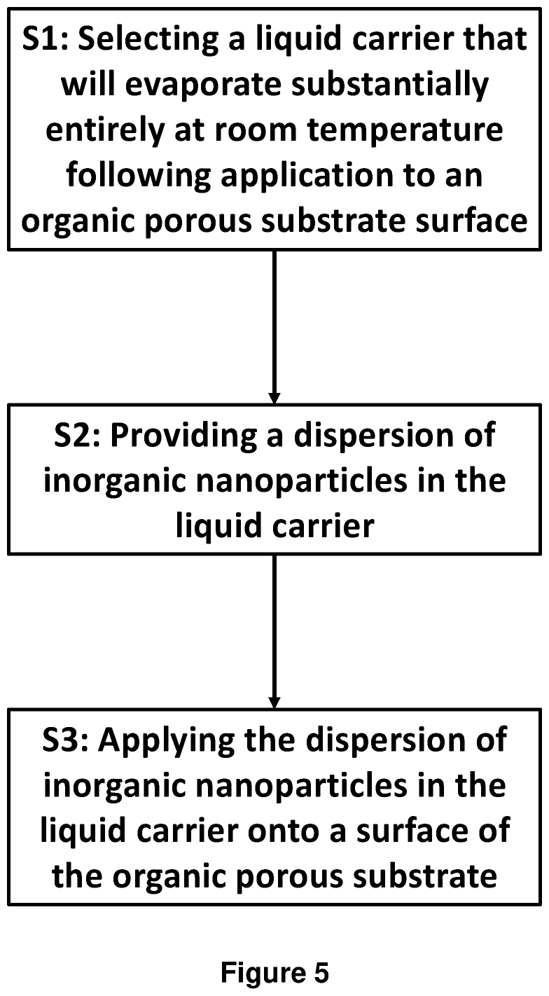

Illustrated in FIG. 5 is a method of increasing water repellency (hydrophobicity) of an organic porous substrate. The method comprises the steps of:

S1: Selecting a liquid carrier, so that the liquid carrier will evaporate substantially entirely at room temperature following application to an organic porous substrate surface;

S2: Providing a dispersion of inorganic nanoparticles in the liquid carrier;

S3: Applying the dispersion of inorganic nanoparticles in the liquid carrier onto a surface of the organic porous substrate.

As discussed above, the pH of an aqueous dispersion, provided in S2 and applied is S3, may be substantially between 1 and 10, preferably between 2 and 9, more preferably between 2.5 and 8 and most between preferably 3 and 7.

As described herein, the term “wood” or “wood-based” or “wood-derived” or “modified wood” may include any type of wood without limitation, including wood used for exterior application, such as Pine, Spruce, Red Cedar, Oak, Douglas fir, Redwood, Iroko, Idigbo, Sapele, Utile, Grandis, Cypress, Ipe, Mahogany, Vertical Grain Fir, Black Walnut, Larch, Meranti and the like, as well as treated wood such as acetylated wood, plywood etc. The term may further encompass without limitation other wood-based materials such as MDF, cardboard, paper, or any other material formed from wood fibres, etc. The substrate to be treated may comprise combinations of such materials. The term may further include wood that has been weathered through exposure to the natural elements and subsequently restored by cleaning the surface of the wood through mechanical and/or by high pressure water and/or by chemicals (e.g. oxalic acid). Some wood-based substrates that are not porous, for example polymer/wood composites where the polymeric component forms the major continuous matrix, are excluded since such materials are inherently hydrophobic and non-porous in nature. The term “lignin-based” may include any material comprising lignin polymers. The term “modified wood” may include wood given enhanced properties by a non-biocidal wood treatment through the cross section of the wood. Some examples of modified wood may be found at https://www.designingbuildings.co.uk/wiki/Modified_wood.

The above description is presented to enable a person of ordinary skill in the art to make and use the various aspects and examples. Descriptions of specific materials, techniques, and applications are provided only as examples. Various modifications to and combinations of the examples described herein will be readily apparent to those of ordinary skill in the art, and the general principles defined herein may be applied to other examples and applications without departing from the scope of the invention. Thus, the invention concept is not intended to be limited to the examples described and shown, but is to be accorded the scope consistent with the claims which follow.

1. A method of increasing water repellency of an organic porous substrate, said method comprising applying a dispersion of cerium oxide nanoparticles in a liquid carrier onto a surface of the substrate, wherein said liquid carrier is selected to evaporate substantially entirely at room temperature following application to the substrate surface.

2.-3. (canceled)

4. The method of claim 1, wherein the liquid carrier is an aqueous carrier whose pH is between 1 and 10, preferably between 2 and 9, more preferably between 2.5 and 8 and most between preferably 3 and 7.

5. (canceled)

6. The method of claim 1, wherein the nanoparticles have sizes in the range 1-500 nm, preferably 1-100 nm, more preferably 1-50 nm, and most preferably 2-30 nm.

7. The method of claim 1, wherein solids content of the nanoparticles in the dispersion is: between 0.1 and 20% by weight, preferably 0.2-10% by weight and most preferably between 0.4 and 5% by weight.

8. The method of claim 1, wherein dried application weight of nanoparticles is: from 0.1 g/sqm to 20 g/sqm, preferably 0.3 g/sqm to 10 g/sqm and most preferably 0.5 g/sqm to 5 g/sqm

9. The method of claim 1, wherein said porous organic substrate comprises one or more of: wood, modified wood, wood-based, wood-derived or lignin-based material.

10. The method of claim 1, said method comprising applying the dispersion of inorganic nanoparticles directly onto the surface of the substrate, and wherein said applying includes treatment by brushing, spraying, dipping, and/or curtain/roller coating.

11. The method of claim 1, wherein said dispersion contains only cerium oxide nanoparticles and the liquid carrier.

12. The method of claim 1, wherein said dispersion contains only cerium oxide nanoparticles, biocides and/or fungicides and the liquid carrier.

13. (canceled)

14. A dispersion of cerium oxide nanoparticles in a liquid carrier for increasing the water repellency of an organic porous substrate, wherein said liquid carrier has the property of evaporating substantially entirely at room temperature following application of the dispersion to a surface of said substrate.

15.-16. (canceled)

17. The dispersion of claim 14, wherein said liquid carrier is an aqueous carrier whose pH is between 1 and 10, preferably between 2 and 9, more preferably between 2.5 and 8 and most preferably between 3 and 7.

18. (canceled)

19. The dispersion of claim 14, wherein said organic porous substrate comprises one or more of: wood, modified wood, wood-based, wood-derived, lignin based material.

20. (canceled)

21. The dispersion of claim 14, wherein following application to a surface of said substrate, the inorganic nanoparticles cause an average total absorption of light in the 400 nm to 500 nm range of at least 4%.

22. (canceled)

23. The method of claim 1, wherein evaporating substantially entirely at room temperature following application of the dispersion to a surface of said substrate comprises evaporation of at least 95% of said liquid carrier within 24 hours following application to the substrate.

24. A porous organic substrate having a hydrophobic treatment, said treatment comprising nanoparticles of cerium oxide.

25. The substrate of claim 24, wherein the treatment consists only of cerium oxide nanoparticles.

26. The substrate of claim 24 comprising one or more of: wood, modified wood, wood-based, wood-derived, lignin-based material.

27. The substrate of claim 24 wherein the cerium oxide nanoparticles are absorbed into a surface region of the substrate.

28. The substrate of claim 24, wherein the treatment also causes an average total absorption of light in the 400 nm to 500 nm range of at least 4%.

29.-32. (canceled)

33. The dispersion of claim 14, wherein evaporating substantially entirely at room temperature following application of the dispersion to a surface of said substrate comprises evaporation of at least 95% of said liquid carrier within 24 hours following application to the substrate.
